(19) United States
(12) Patent Application Publication
(10) Pub. No.: US 2016/0153648 A1
(43) Pub. Date: Jun. 2, 2016

(54) OPTICAL SEMICONDUCTOR LIGHTING APPARATUS

(71) Applicant: POSCO LED COMPANY, LTD., Seongnam-si (KR)

(72) Inventors: Su Woon LEE, Seongnam-si (KR); Hyun Ku Park, Seongnam-si (KR); Sang Hyuk Kim, Seongnam-si (KR); Jung Hwa Kim, Seongnam-si (KR)

(21) Appl. No.: 14/557,896

(22) Filed: Dec. 2, 2014

(51) Int. Cl. F21V 29/76; F21V 19/00; F21V 23/00; F21V 29/83; F21S 6/00; F21V 27/00

(52) U.S. Cl. CPC F21V 29/763; F21S 6/006; F21V 27/00; F21V 23/002; F21V 29/83; F21V 19/0055; F21W 2131/10

(57) ABSTRACT

An optical semiconductor light apparatus includes: a first light emitting block including one or more first light emitting modules; a junction box formed on one side surface of the first light emitting block and fastened to an end portion of a column; and at least one second light emitting block disposed on the other side surface of the first light emitting block and including one or more second light emitting modules, wherein the first and second light emitting modules are formed on one side thereof with one or more optical semiconductor devices and on the other side thereof with a plurality of heat dissipation fins, and the heat dissipation fins are received in the first and second light emitting blocks and formed in a direction in which the second light emitting block is coupled to the first light emitting block.

### BACKGROUND

1. Field

The present invention relates to an optical semiconductor lighting apparatus, and more particularly, to an optical semiconductor lighting apparatus which can achieve excellent drainage performance, simple assembly and fastening, excellent heat dissipation efficiency, and desired control of luminous flux.

2. Discussion of the Background

Optical semiconductor devices, such as light emitting diodes (LEDs) or laser diodes (LDs), have attracted increasing attention due to advantages such as low power consumption, long lifespan, high durability, and excellent brightness, as compared with incandescent lamps or fluorescent lamps.

Unlike fluorescent lamps or mercury lamps manufactured by injecting argon gas and toxic mercury into a glass tube, optical semiconductor devices do not use substances toxic to the environment, thereby providing eco-friendly products.

Particularly, lighting apparatuses using optical semiconductor devices as a light source are recently employed for outdoor landscape lighting or security, and thus easy assembly and installation are required. In addition, lighting apparatuses are used while being exposed to the air, and thus drainage performance must be considered to prevent electric components from being directly affected by moisture.

In addition, such lighting apparatuses using optical semiconductor devices as a light source are required to allow replacement or repair upon failure and malfunction.

The above information disclosed in this Background section is only for enhancement of understanding of the background of the inventive concept, and, therefore, it may contain information that does not form the prior art that is already known in this country to a person of ordinary skill in the art.

### SUMMARY

The present invention has been conceived to solve such problems in the related art and is aimed at providing an optical semiconductor lighting apparatus which can achieve excellent drainage performance, simple assembly and fastening, excellent heat dissipation efficiency, and desired control of luminous flux.

Additional aspects will be set forth in the detailed description which follows, and, in part, will be apparent from the disclosure, or may be learned by practice of the inventive concept.

In accordance with one aspect of the present invention, an optical semiconductor lighting apparatus includes: a first light emitting block including one or more first light emitting modules; a junction box formed on one side surface of the first light emitting block and fastened to an end portion of a column; and at least one second light emitting block disposed on the other side surface of the first light emitting block and including one or more second light emitting modules, wherein the first and second light emitting modules are formed on one side thereof with one or more optical semiconductor devices and on the other side thereof with a plurality of heat dissipation fins, and the heat dissipation fins are received in the first and second light emitting blocks and formed in a direction in which the second light emitting block is coupled to the first light emitting block.

The end portion of the column may be inclined at a predetermined angle with respect to the column.

The second light emitting block may be coupled to the first light emitting block in a direction parallel to that in which the end portion of the column is formed.

The first light emitting block may include a pair of first sidewalls aligned with both side surfaces of the junction box and facing each other, and a first cover connecting upper ends of the first sidewalls.

The first light emitting modules may be arranged between the first sidewalls.

The optical semiconductor lighting apparatus may further include: a first rib protruding to a predetermined height toward the first light emitting modules along both edges of the first cover; and a first cutaway slot formed in a circular arc shape at a central portion of the first rib, wherein interconnection wire may be arranged through the first cutaway slot.

The optical semiconductor lighting apparatus may further include a plurality of first vent slots formed at constant intervals on both sides of the first cover.

The first vent slots may be formed in a direction perpendicular to that in which the heat dissipation fins are formed.

The optical semiconductor lighting apparatus may further include: at least two first regions where the first vent slots are formed through the first cover; and one or more cable glands disposed on the other side of the first light emitting modules and electrically connected to the first light emitting modules, wherein the cable glands may be arranged to face an inner surface of the first cover between the first regions.

The optical semiconductor lighting apparatus may further include: one first region comprise the first vent slots are formed through the first cover; and at least one cable glands disposed on the other side of the first light emitting modules and electrically connected to the first light emitting modules, wherein the cable glands are arranged to face an inner surface of the first cover except the first region.

The optical semiconductor lighting apparatus may further include a first support plate disposed on a bottom surface of the first light emitting block and formed with first fastening slots to which the first light emitting modules are secured.

One or more first fastening slots may be formed through the first support plate.

The second light emitting block may include a pair of second sidewalls aligned with both side surfaces of the first light emitting block and facing each other, and a second cover connecting upper ends of the second sidewalls.

The second light emitting modules may be arranged between the second sidewalls.

The optical semiconductor lighting apparatus may further include a second rib protruding to a predetermined height toward the second light emitting modules along both edges of the second cover, and a second cutaway slot formed in a circular arc shape at a central portion of the second rib, wherein interconnection wire may be arranged through the second cutaway slot.

The optical semiconductor lighting apparatus may further include a plurality of second vent slots formed at constant intervals on both sides of the second cover.

The second vent slots may be formed in a direction perpendicular to that in which the heat dissipation fins are formed.

The optical semiconductor lighting apparatus may further include: at least two second regions where the second vent slots are formed through the second cover, and one or more cable glands disposed on the other side of the second light emitting modules and electrically connected to the second light emitting modules, wherein the cable glands may be arranged to face an inner surface of the second cover between the second regions.

The optical semiconductor lighting apparatus may further include: one second region comprise the second vent slots are formed through the second cover; and at least one cable glands disposed on the other side of the second light emitting modules and electrically connected to the second light emitting modules, wherein the cable glands are arranged to face an inner surface of the second cover except the second region.

The optical semiconductor lighting apparatus may further include a second support plate disposed on a bottom surface of the second light emitting block and formed therethrough with second fastening slots to which the second light emitting modules are secured.

One or more second fastening slots may be formed through the second support plate.

The optical semiconductor lighting apparatus may further include a through-hole formed through one side surface of the junction box, and a securing unit securing an outer peripheral surface of the end portion of the column inserted through the through-hole.

In accordance with another aspect of the present invention, an optical semiconductor lighting apparatus includes a light emitting block including a light emitting module formed on one side thereof with one or more optical semiconductor devices and on the other side thereof with a plurality of heat dissipation fins, a pair of sidewalls facing each other, a cover connecting upper ends of the sidewalls, and a plurality of vent slots formed at constant intervals on both sides of the cover, wherein the cover includes a plurality of slot regions where the vent slots are formed through the cover and one or more cable glands disposed on the other side of the light emitting module and electrically connected to the light emitting module, and the cable glands are arranged to face an inner surface of the cover between the slot regions.

The vent slots may be formed in a direction perpendicular to that in which the heat dissipation fins are formed.

The vent slots may be arranged on the other side of the light emitting module.

The optical semiconductor lighting apparatus according to the embodiments of the present invention has the following advantages.

In the structure in which the first light emitting block is coupled to one side of the junction box, at least one second light emitting block is attached to one side of the first light emitting block, and the heat dissipation fins are formed in one direction on the upper surfaces of the first and second light emitting modules embedded in the first and second light emitting blocks, respectively, the heat dissipation fins are formed in the direction in which the second light emitting block is coupled to the first light emitting block, thereby enhancing drainage performance and thus preventing malfunction, electric leakage and shock caused by moisture or foreign matter.

In addition, one or more first and second light emitting blocks can be detachably attached to one side of the junction box, thereby achieving simple assembly and fastening.

Further, a proper number of first and second light emitting modules can be arranged in the first and second light emitting blocks, respectively, thereby achieving desired control of luminous flux.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a perspective view showing an entire structure of an optical semiconductor lighting apparatus according to one embodiment of the invention, when viewed from a bottom surface of a junction box which is a major component of the invention.

FIG. 2 is a plan view showing the entire structure of the optical semiconductor lighting apparatus according to the embodiment of the invention, when viewed from a viewpoint A of FIG. 1.

FIG. 3 is an exploded perspective view showing an entire structure of first and second light emitting blocks, which are major components of the optical semiconductor lighting apparatus according to the embodiment of the invention.

FIG. 4 is a sectional view showing a state in which first and second light emitting modules, which are major components of the invention, are fastened to first and second support plates, when viewed from a viewpoint B of FIG. 1.

FIG. 5 is bottom views showing various embodiments in which first and second light emitting modules, which are major components of the invention are arranged, when viewed from a viewpoint C of FIG. 1.

FIG. 6 is a partial sectional view showing a state in which an end portion of a column is coupled to a junction box, which is a major component of the invention, when viewed from the viewpoint B of FIG. 1.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

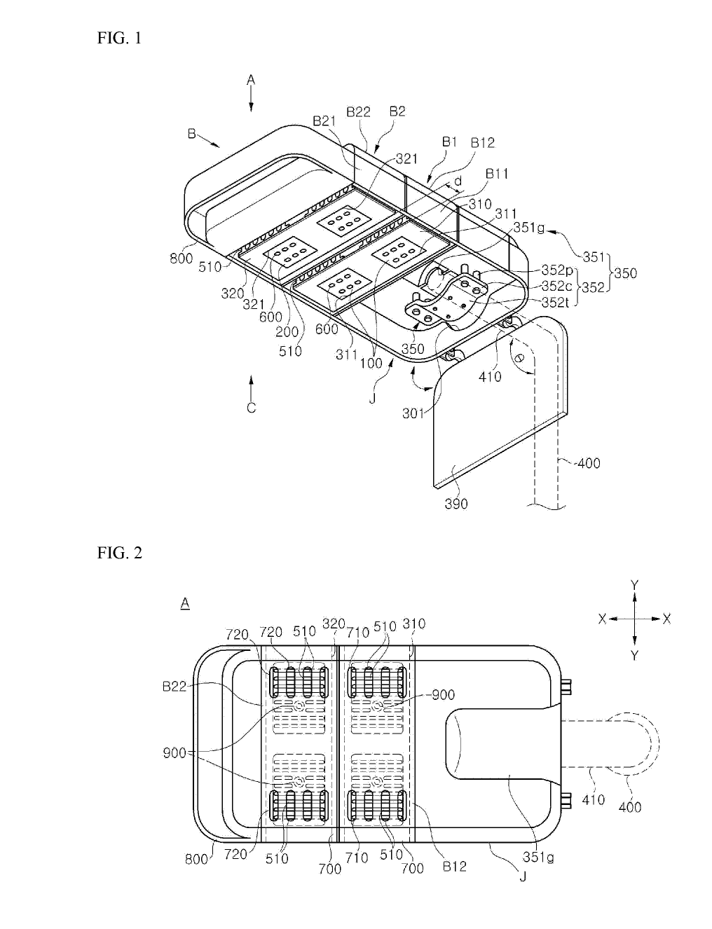

FIG. 1 is a perspective view showing an entire structure of an optical semiconductor lighting apparatus according to one embodiment of the invention, when viewed from a bottom surface of a junction box which is a major component of the invention, and FIG. 2 is a plan view showing the entire structure of the optical semiconductor lighting apparatus according to the embodiment of the invention, when viewed from viewpoint A of FIG. 1.

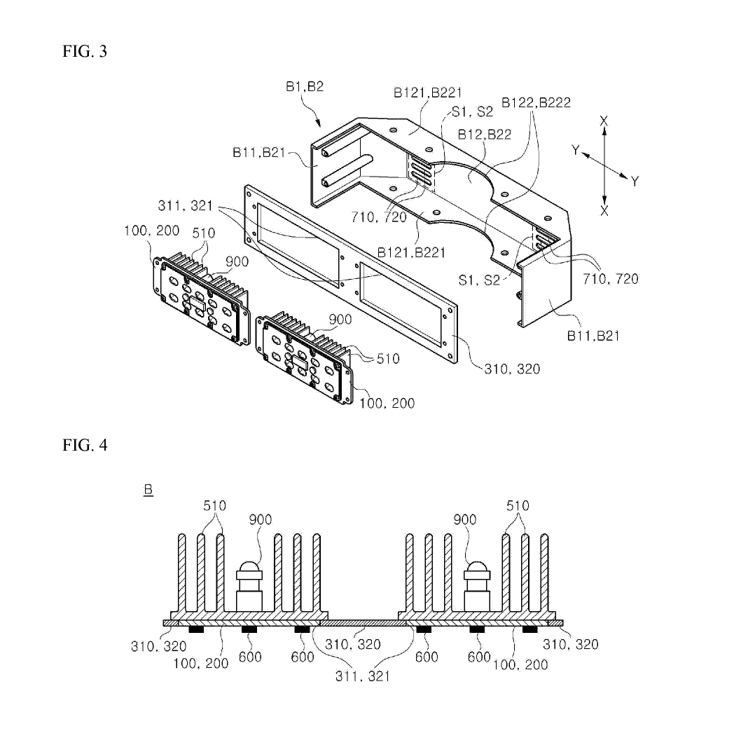

FIG. 3 is an exploded perspective view showing an entire structure of first and second light emitting blocks, which are major components of the optical semiconductor lighting apparatus according to the embodiment of the invention.

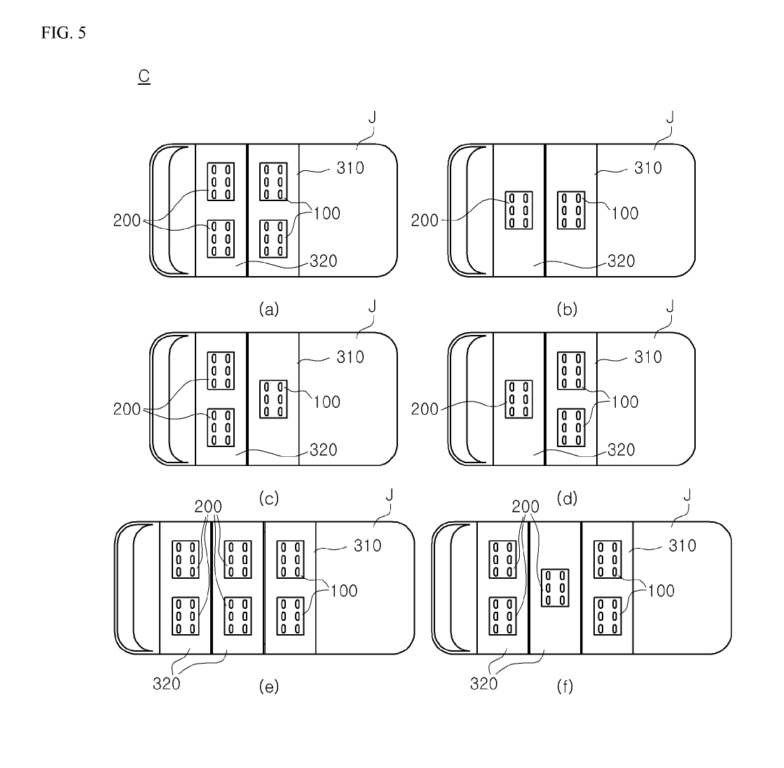

FIG. 4 is a sectional view showing a state in which first and second light emitting modules, which are major components of the invention, are fastened to first and second support plates, when viewed from a viewpoint B of FIG. 1, and FIG. 5 is bottom views showing various embodiments in which first and second light emitting modules which are major components of the invention are arranged, when viewed from a viewpoint C of FIG. 1.

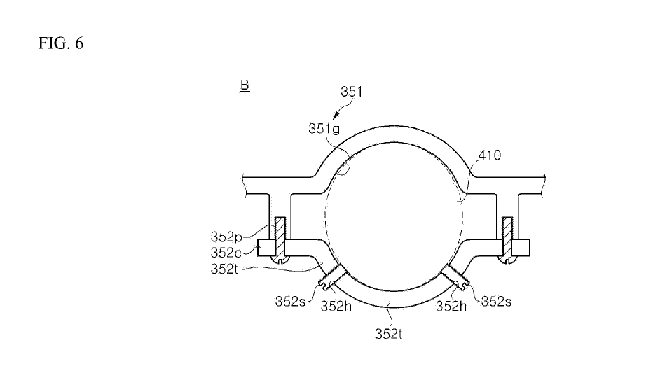

FIG. 6 is a sectional view showing a state in which an end portion of a column is coupled to a junction box, which is a major component of the invention, when viewed from the viewpoint B of FIG. 1.

For reference, reference numeral 390 in FIG. 1 denotes an opening/closing member that may be opened or closed for internal inspection.

A first light emitting block B1 includes one or more first light emitting modules 100 functioning as a light source.

A junction box J is disposed on one side surface of the first light emitting block B1 and fastened to an end portion 410 of a column 400 for connection to a power supply.

At least one second light emitting block B2 is disposed on the other side surface of the first light emitting block B1 and includes one or more second light emitting modules 200 functioning as a light source together with the first light emitting modules 100.

The first and second light emitting modules 100, 200 are formed on one side thereof with one or more optical semiconductor devices 600 and on the other side thereof with a plurality of heat dissipation fins 510.

The heat dissipation fins 510 are received in the first and second light emitting blocks B1, B2.

The heat dissipation fins 510 are formed in a direction in which the second light emitting block B2 is coupled to the first light emitting block B1, thereby allowing rainwater or snow introduced into the first and second light emitting modules 100, 200 to smoothly flow downward through spaces therebetween.

It should be understood that the following various embodiments as well as the above embodiment may be applied to the present invention.

As described above, the heat dissipation fins 510 may be formed in the direction in which the second light emitting block B2 is coupled to the first light emitting block B1, thereby enhancing drainage efficiency. To this end, the end portion 410 of the column 400 is preferably inclined at a predetermined angle with respect to the column 400.

That is, the end portion 410 of the column 400 is formed in a direction parallel to that in which the second light emitting block B2 is coupled.

As a result, water, moisture, or foreign matter introduced into the first and second light emitting blocks B1, B2 from the outside flows down the column 400 via an outer peripheral surface of the end portion 410 of the column 400.

In addition, with such a drainage structure, the second light emitting block B2 is preferably separated a predetermined distance (d) from the first light emitting block B1 in order to achieve smooth drainage of water, moisture, or foreign matter and high heat dissipation efficiency.

Further, with such a drainage structure, when a plurality of second light emitting blocks B2 is attached to the first light emitting block B1, some of the second light emitting blocks B2 adjacent to the first light emitting block B1 are preferably separated from each other in order to achieve smooth drainage of water, moisture, or foreign matter and high heat dissipation efficiency.

As shown in FIG. 1, the first light emitting block B1 includes a pair of first sidewalls B11 aligned with both side surfaces of the junction box J and facing each other and a first cover B12 connecting upper ends of the first sidewalls B11.

The first cover B12 protects embedded components from external shock and prevents infiltration of moisture, dust, or foreign matter.

Here, the first light emitting modules 100 are arranged between the first sidewalls B11.

As shown in FIG. 3, the first light emitting block B1 may further include first ribs B121 and first cutaway slots B122 to detachably couple the first light emitting block B1 to the junction box J and to conveniently arrange an interconnection wire.

That is, the first ribs B121 protrude to a predetermined height toward the first light emitting modules 100 along both edges of the first cover B12.

The first cutaway slots B122 are formed in a circular arc shape at a central portion of the first ribs B121.

Therefore, the interconnection wire (not shown) may be arranged through the first cutaway slots B122.

In order to solve a problem of internal heat generation caused by the first light emitting modules 100, the first light emitting block B1 may further include a plurality of first vent slots 710 formed at constant intervals on both sides of the first cover B12 to release heat, generated from the optical semiconductor devices 600, through natural or forced convection.

More specifically, the first cover B12 covers upper surfaces of the first light emitting modules 100, namely, upper portions of the heat dissipation fins 510, and the first vent slots 710 are formed in the shape of long holes at constant intervals in regions separated a predetermined distance from both edges of the first cover B12.

The first vent slots 710 are formed in a direction perpendicular to that in which the heat dissipation fins 510 are formed (refer to X and Y axis directions shown in FIGS. 2 and 3).

Such arrangement of the first vent slots 710 serves to minimize moisture infiltration and enhance sealing performance while maintaining heat dissipation performance.

For wire interconnection and maintenance of waterproof sealing, the first light emitting block B1 may further include one or more cable glands 900 disposed on the other side of the first light emitting modules 100 such that the interconnection wire electrically connected to the first light emitting module 100 passes therethrough.

When the regions where the first vent slots 710 are formed through the first cover B12 are set as first regions 51 (see FIG. 3), the cable glands 900 are arranged to face each other between the first regions 51 so as not to be directly exposed to freely falling moisture, such as rainwater or snow, whereby the lighting apparatus can be used stably.

As shown in FIGS. 3 and 4, the first light emitting block B1 may further include a first support plate 310 to control luminous flux at a desired level by properly adjusting the number of first light emitting modules 100.

The first support plate 310 is disposed on a bottom surface of the first light emitting block B1 and is formed therethrough with a first fastening slot 311 to which the first light emitting module 100 is secured.

As shown in FIG. 5, one or more first fastening slots 311 may be formed through the first support plate 310, whereby a desired number of first light emitting modules 100 can be secured to the first fastening slots 311, thereby enabling control of luminous flux at a desired level.

Referring again to FIG. 1, the second light emitting block B2 includes a pair of second sidewalls B21 aligned with both side surfaces of the first light emitting block B1 and facing each other and a second cover B22 connecting upper ends of the second sidewalls B21.

The second cover B22 protects embedded components from external shock and prevents infiltration of moisture, dust, or foreign matter.

Here, the second light emitting modules 200 are arranged between the second sidewalls B21.

Referring again to FIG. 3, the second light emitting block B2 may further include second ribs B221 and second cutaway slots B222 to detachably couple the second light emitting block B2 to the junction box J and conveniently arrange an interconnection wire.

The second ribs B221 protrude to a predetermined height toward the second light emitting modules 200 along both edges of the second cover B22.

Each of the second cutaway slots B222 is formed in a circular arc shape at a central portion of the second rib B221.

Therefore, the interconnection wire may be arranged through the second cutaway slots B222.

In order to solve a problem of internal heat generation caused by the second light emitting modules 200, the second light emitting block B2 may further include a plurality of second vent slots 720 formed at constant intervals on both sides of the second cover B22 to release heat, generated from the optical semiconductor devices 600, through natural or forced convection.

More specifically, the second cover B22 covers upper surfaces of the second light emitting modules 200, namely, upper portions of the heat dissipation fins 510, and the second vent slots 720 are formed in the shape of long holes at constant intervals in regions separated a predetermined distance from both edges of the second cover B22.

The second vent slots 720 are formed in a direction perpendicular to that in which the heat dissipation fins 510 are formed (refer to X and Y axis directions shown in FIGS. 2 and 3).

The layout of the second vent slots 720 serves to minimize moisture infiltration and further enhances waterproofing and sealing performance while maintaining heat dissipation performance.

For wire interconnection and maintenance of waterproof sealing, the second light emitting block B2 may further include one or more cable glands 900 disposed on the other side of the second light emitting modules 200 such that the interconnection wire electrically connected to the second light emitting module 200 passes therethrough.

When the regions where the second vent slots 720 are formed through the second cover B22 are set as second regions S2 (see FIG. 3), the cable glands 900 are arranged to face each other between the second regions S2 so as not to be directly exposed to freely falling moisture, such as rainwater or snow, thereby stably using the lighting apparatus.

Referring again to FIGS. 3 and 4, the second light emitting block B2 may further include a second support plate 320 to control luminous flux at a desired level by properly adjusting the number of second light emitting modules 200.

The second support plate 320 is disposed on a bottom surface of the second light emitting block B2 and formed therethrough with second fastening slots 321 to which the second light emitting modules 200 are secured.

Referring again to FIG. 5, one or more second fastening slots 321 may be formed through the second support plate 320, whereby a desired number of second light emitting modules 200 is secured to the second fastening slots 321, thus controlling luminous flux at a desired level.

The second support plate 320 is disposed parallel to the first support plate 310 while being separated a predetermined distance (d) from the first support plate 310, thereby implementing drainage and heat dissipation functions.

Therefore, the entire luminous flux of the lighting apparatus may be controlled by positioning as many first and second light emitting modules 100, 200 as the first and second fastening slots 311, 321.

Referring to FIGS. 1 and 6, the optical semiconductor lighting apparatus may further include a through-hole 301 formed through a side surface of the junction box J, and a securing unit 350 securing the outer peripheral surface of the end portion 410 of the column 400 inserted through the through-hole 301.

That is, the securing unit 350 is used to tightly secure the end portion 410 of the column 400 having a different diameter and cross-sectional shape. The securing unit 350 may include a first securing portion 351 formed at the junction box J to be connected to one edge of the through-hole 301 and supporting one side of the outer peripheral surface of the end portion 410 of the column 400, and a second securing portion 352 coupled to both sides of the first securing portion 351 and supporting the other side of the outer peripheral surface of the end portion 410 of the column 400.

The first securing portion 351 includes a positioning recess 351g convexly formed on an upper surface of the junction box J to have a shape corresponding to one portion of an outer peripheral surface of a cylinder, and the second securing portion 352 is coupled to regions outside both edges of the positioning recess 351g.

The second securing portion 352 may include one or more securing protrusions 352p formed along the regions outside both edges of the first securing portion 351, a pair of fastening pieces 352c coupled to the securing protrusions 352p, and a contact piece 352t connected at both ends thereof to the fastening pieces 352 and contacting the other side of the outer peripheral surface of the end portion 410 of the column 400.

In addition, the second securing portion 352 may further include fastening holes 352h formed, parallel to the fastening pieces 352c, through the contact piece 352t and a plurality of stud bolts 352s screwed to the fastening holes 352h in a direction perpendicular to the outer peripheral surface of the end portion 410 of the column 400 to secure the end portion 410.

The stud bolts 352s are mechanical components for increasing a fastening force by contacting the outer peripheral surface of the end portion 410 of the column 400 between the first and second securing portions 351, 352 and increasing securing positions and areas.

As described above, the embodiments of the invention provide the optical semiconductor lighting apparatus which can achieve excellent drainage performance, simple assembly and fastening, excellent heat dissipation efficiency, and desired control of luminous flux.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. An optical semiconductor lighting apparatus, comprising:
a first light emitting block comprising at least one first light emitting modules;
a junction box formed on one side surface of the first light emitting block and fastened to an end portion of a column; and
at least one second light emitting block disposed on the other side surface of the first light emitting block and comprising at least one second light emitting modules,
wherein the first and second light emitting modules are formed on one side thereof with one or more optical semiconductor devices and on the other side thereof with a plurality of heat dissipation fins, and the heat dissipation fins are received in the first and second light emitting blocks and formed in a direction in which the second light emitting block is coupled to the first light emitting block.

2. The optical semiconductor lighting apparatus according to claim 1, wherein the end portion of the column is inclined at a predetermined angle with respect to the column.

3. The optical semiconductor lighting apparatus according to claim 1, wherein the second light emitting block is coupled to the first light emitting block in a direction parallel to that in which the end portion of the column is formed.

4. The optical semiconductor lighting apparatus according to claim 1, wherein the first light emitting block comprises:
a pair of first sidewalls aligned with both side surfaces of the junction box and facing each other; and
a first cover connecting upper ends of the first sidewalls.

5. The optical semiconductor lighting apparatus according to claim 4, wherein the first light emitting modules are arranged between the first sidewalls.

6. The optical semiconductor lighting apparatus according to claim 4, further comprising:
a first rib protruding to a predetermined height toward the first light emitting modules along both edges of the first cover; and
a first cutaway slot formed in a circular arc shape at a central portion of the first rib,
wherein an interconnection wire is arranged through the first cutaway slot.

7. The optical semiconductor lighting apparatus according to claim 4, further comprising:
a plurality of first vent slots formed at constant intervals on both sides of the first cover.

8. The optical semiconductor lighting apparatus according to claim 7, wherein the first vent slots are formed in a direction perpendicular to that in which the heat dissipation fins are formed.

9. The optical semiconductor lighting apparatus according to claim 7, further comprising:
at least two first regions where the first vent slots are formed through the first cover; and
at least one cable gland disposed on the other side of the first light emitting modules and electrically connected to the first light emitting modules,
wherein the at least one cable gland is arranged to face an inner surface of the first cover between the first regions.

10. The optical semiconductor lighting apparatus according to claim 4, further comprising:
one first region comprising the first vent slots are formed through the first cover; and
at least one cable gland disposed on the other side of the first light emitting modules and electrically connected to the first light emitting modules,
wherein the at least one cable gland is arranged to face an inner surface of the first cover except the first region.

11. The optical semiconductor lighting apparatus according to claim 1, further comprising:
a first support plate disposed on a bottom surface of the first light emitting block and formed with first fastening slots to which the first light emitting modules are secured.

12. The optical semiconductor lighting apparatus according to claim 11, wherein one or more first fastening slots are formed through the first support plate.

13. The optical semiconductor lighting apparatus according to claim 1, wherein the second light emitting block comprises:
a pair of second sidewalls aligned with both side surfaces of the first light emitting block and facing each other; and
a second cover connecting upper ends of the second sidewalls.

14. The optical semiconductor lighting apparatus according to claim 13, wherein the second light emitting modules are arranged between the second sidewalls.

15. The optical semiconductor lighting apparatus according to claim 13, further comprising:
a second rib protruding to a predetermined height toward the second light emitting modules along both edges of the second cover; and
a second cutaway slot formed in a circular arc shape at a central portion of the second rib,
wherein an interconnection wire is arranged through the second cutaway slot.

16. The optical semiconductor lighting apparatus according to claim 12, further comprising:
a plurality of second vent slots formed at constant intervals on both sides of the second cover.

17. The optical semiconductor lighting apparatus according to claim 16, wherein the second vent slots are formed in a direction perpendicular to that in which the heat dissipation fins are formed.

18. The optical semiconductor lighting apparatus according to claim 16, further comprising:
at least two second regions where the second vent slots are formed through the second cover; and
at least one cable gland disposed on the other side of the second light emitting modules and electrically connected to the second light emitting modules,
wherein the at least one cable gland is arranged to face an inner surface of the second cover between the second regions.

19. The optical semiconductor lighting apparatus according to claim 13, further comprising:
one second region comprise the second vent slots are formed through the second cover; and
at least one cable gland disposed on the other side of the second light emitting modules and electrically connected to the second light emitting modules,
wherein the at least one cable gland is arranged to face an inner surface of the second cover except the second region.

20. The optical semiconductor lighting apparatus according to claim 1, further comprising:
a second support plate disposed on a bottom surface of the second light emitting block and formed therethrough with second fastening slots to which the second light emitting modules are secured.

21. The optical semiconductor lighting apparatus according to claim 20, wherein at least one second fastening slot is formed through the second support plate.

22. The optical semiconductor lighting apparatus according to claim 1, further comprising:
a through-hole formed through one side surface of the junction box; and
a securing unit securing an outer peripheral surface of the end portion of the column inserted through the through-hole.

23. An optical semiconductor lighting apparatus, comprising:
a light emitting block comprising a light emitting module formed on one side thereof with at least one optical semiconductor devices and on the other side thereof with a plurality of heat dissipation fins, a pair of sidewalls facing each other, a cover connecting upper ends of the sidewalls, and a plurality of vent slots formed at constant intervals on both sides of the cover,
wherein the cover comprises a plurality of slot regions where the vent slots are formed through the cover, and one or more cable glands disposed on the other side of the light emitting module and electrically connected to the light emitting module, the cable glands being arranged to face an inner surface of the cover between the slot regions.

24. The optical semiconductor lighting apparatus according to claim 23, wherein the vent slots are formed in a direction perpendicular to that in which the heat dissipation fins are formed.

25. The optical semiconductor lighting apparatus according to claim 23, wherein the vent slots are arranged on the other side of the light emitting module.
